(19) United States
(12) Patent Application Publication
(10) Pub. No.: US 2017/0347362 A1
(43) Pub. Date: Nov. 30, 2017

(54) METHOD OF CONTROLLING WIRELESS COMMUNICATION CHANNELS, WIRELESS COMMUNICATION NETWORK, AND WIRELESS COMMUNICATION DEVICE

(71) Applicant: FUJITSU LIMITED, Kawasaki-shi, Kanagawa (JP)

(72) Inventor: Shiho Nakahara, Nerima (JP)

(73) Assignee: FUJITSU LIMITED, Kawasaki-shi, Kanagawa (JP)

(21) Appl. No.: 15/499,830

(22) Filed: Apr. 27, 2017

(30) Foreign Application Priority Data
May 25, 2016 (JP) 2016-104185

(51) Int. Cl. H04W 72/08; H04L 12/24; H04W 4/00

(52) U.S. Cl. CPC H04W 72/082; H04L 41/12; H04W 4/008

(57) ABSTRACT

A method of controlling wireless communication channels used in a plurality of wireless communication networks, the method includes performing, by a first wireless communication network, wireless communication using a first wireless channel, performing, by a second wireless communication network, wireless communication using of the first wireless channel, identifying a first value indicating a number of the wireless communication networks each of which performs wireless communication using the first wireless channel interfering with the wireless communication in the first wireless communication network, identifying a second value indicating a number of the wireless communication networks each of which performs wireless communication using the first wireless channel interfering with the wireless communication in the second wireless communication network, and switching, when the first value is greater than the second value the first wireless channel used by the first wireless communication network to a second wireless channel.

### CROSS-REFERENCE TO RELATED APPLICATION

This application is based upon and claims the benefit of priority of the prior Japanese Patent Application No. 2016-104185, filed on May 25, 2016, the entire contents of which are incorporated herein by reference.

### FIELD

The present disclosure is related to a method of controlling wireless communication channels, a wireless communication network, and a wireless communication device.

### BACKGROUND

In the past, there has been studied a short distance wireless communication network such as a body area network (body area network: BAN) in which communication is performed between communication devices attached to a human body. Such a short distance wireless communication network is installed for each of moving objects such as, for example, persons, in some cases. Therefore, in a case where moving objects each wearing such a short distance wireless communication network move closer to each other, there is a possibility that an interference occurs between the short distance wireless communication networks. In particular, in a case where the short distance wireless communication networks each use the same channel of wireless communication, an interference may occur.

On the other hand, a technology for switching a channel of wireless communication at a time of the occurrence of an interference is studied.

In a wireless communication network, in a case where a base station device detects an interference with another wireless communication network, the base station device determines whether or not to switch a wireless channel used for communication with a wireless communication terminal, and in a case of determining that the switching is to be performed, the base station device switches the wireless channel. In addition, in accordance with a combination of an identifier of the other wireless communication network, received from the other wireless communication network, and an identifier of the wireless communication network to which the base station device belongs, the base station device determines whether or not to switch the wireless channel. As a document of the related art, there is Japanese Laid-open Patent Publication No. 2014-45452.

### SUMMARY

According to an aspect of the invention, a method of controlling wireless communication channels used in a plurality of wireless communication networks including a first wireless communication network and a second wireless communication network, each of the plurality of wireless communication networks including a plurality of wireless communication devices, the method includes performing, by a first wireless communication device included in the first wireless communication network, wireless communication using a first wireless channel, performing, by a second wireless communication device included in the second wireless communication network, wireless communication using of the first wireless channel, identifying, by the first wireless communication device, a first value indicating a number of the wireless communication networks which are included in the plurality of wireless communication networks and which are other than the first wireless communication network, and each of which performs wireless communication using the first wireless channel interfering with the wireless communication in the first wireless communication device, identifying, by the second wireless communication device, a second value indicating a number of the wireless communication networks which are included in the plurality of wireless communication networks and which are other than the second wireless communication network, and each of which performs wireless communication using the first wireless channel interfering with the wireless communication in the second wireless communication device, obtaining, by the first wireless communication from the second wireless communication device, the second value, and switching, when the first value is greater than the second value, by the first wireless communication device, the first wireless channel used in the wireless communication in the first wireless communication network to a second wireless channel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of a wireless communication network based on the present embodiment.

FIG. 2A is a diagram illustrating examples of wireless communication networks using the same channel before channel switching.

FIG. 2B is a diagram illustrating examples of the wireless communication networks after one of the wireless communication networks switches a channel.

FIG. 3 is a sequence diagram illustrating a procedure of channel switching in each of the wireless communication networks illustrated in FIG. 2A and FIG. 2B.

FIG. 4A is a diagram illustrating a case where a hub of one of wireless communication networks is able to receive a wireless signal from a hub of the other of the wireless communication networks.

FIG. 4B is a diagram illustrating a case where one of nodes of one of the wireless communication networks is able to receive a wireless signal from a hub of the other of the wireless communication networks.

FIG. 5 is a schematic configuration diagram of a node.

FIG. 6 is a schematic configuration diagram of a hub.

FIG. 7 is an operation flowchart of channel switching processing.

FIG. 8 is a diagram illustrating an example of a case where wireless communication networks each having the maximum number of sensed networks exist.

FIG. 9 is an operation flowchart of channel switching processing based on an example of a modification.

### DESCRIPTION OF EMBODIMENTS

In the above-mentioned switching of a wireless channel, in a case where three or more wireless communication networks use the same wireless channel, an interference occurs for combinations of wireless communication networks in some cases. In such a case, switching of a wireless channel is determined for each of the combinations. Therefore, wireless channels are switched for two or more wireless communication networks, and an interference occurs again in wireless communication networks after the switching, in some cases.

Hereinafter, a wireless communication network and a communication device and a channel switching method that are used in the wireless communication network will be described with reference to drawings. This wireless communication network includes communication devices, for example. In a case where wireless signals from other wireless communication networks are able to be received in a wireless communication channel used for wireless communication between communication devices, this wireless communication network counts, as the number of sensed networks, the number of the other wireless communication networks that transmit the respective wireless signals. In addition, this wireless communication network notifies the other wireless communication networks of the number of sensed networks of the self-system and receives the number of sensed networks from each of the other wireless communication networks, thereby sharing the numbers of sensed networks of the respective wireless communication networks. In addition, in a case where the number of sensed networks of the self-system is a maximum among the number of sensed networks of the self-system and the numbers of sensed networks of the other wireless communication networks, this wireless communication network switches a currently used channel for wireless communication to another channel. Note that hereinafter the channel for wireless communication will be simply called a channel.

In the present embodiment, communication devices within a wireless communication network each perform wireless communication with other communication devices in accordance with a short distance wireless communication method compliant with IEEE802.15.6. However, each of the communication devices may perform wireless communication with other communication devices in accordance with a communication method compliant with another wireless communication standard able to switch a channel to be used among channels.

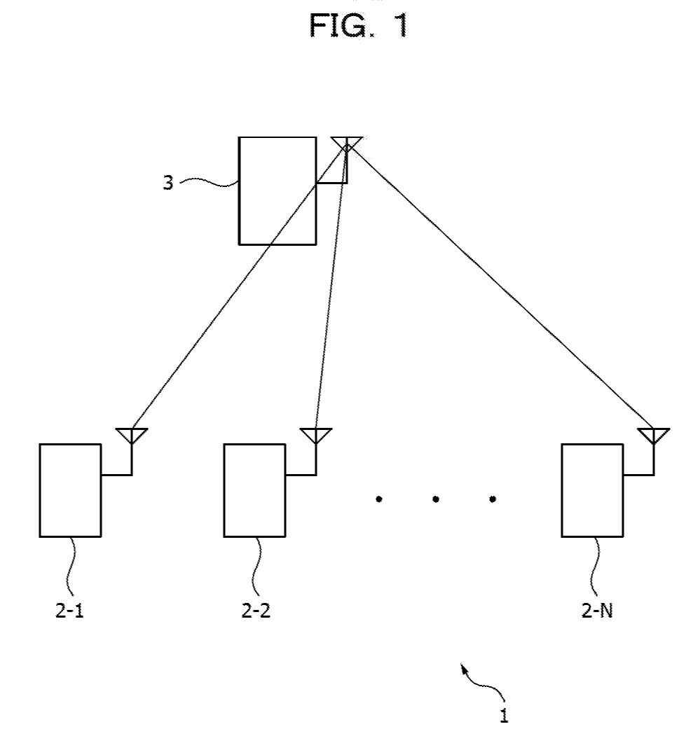

FIG. 1 is a schematic configuration diagram of a wireless communication network based on the present embodiment. A wireless communication network 1 includes N nodes 2-1 to 2-N(N is an integer greater than or equal to one) and a hub 3.

Each of the nodes 2-1 to 2-N and the hub 3 is an example of a communication device and is a portable communication terminal attached to, for example, the same test subject. The nodes 2-1 to 2-N each perform wireless communication with the hub 3. In addition, the hub 3 is able to perform wireless communication with each of the nodes and an access point (not illustrated) installed in a predetermined place (a room where the test subject to which the wireless communication network 1 is attached is, for example). In addition, the hub 3 relays wireless signals received from, for example, the respective nodes 2-1 to 2-N and transmits the wireless signals to the access point. Alternatively, the hub 3 may transmit, to the access point, wireless signals generated based on the wireless signals received from the respective nodes 2-1 to 2-N, or the like.

In wireless communication between each of the nodes 2-1 to 2-N and the hub 3, two or more channels are available. In addition, by using a channel, included in those channels and selected by the hub 3, wireless communication between each of the nodes 2-1 to 2-N and the hub 3 is performed. Note that, in the present embodiment, a different frequency is allocated for each of the channels and wireless communication is performed by using a wireless signal having a frequency corresponding to that channel.

Hereinafter, an outline of switching processing of a channel will be described.

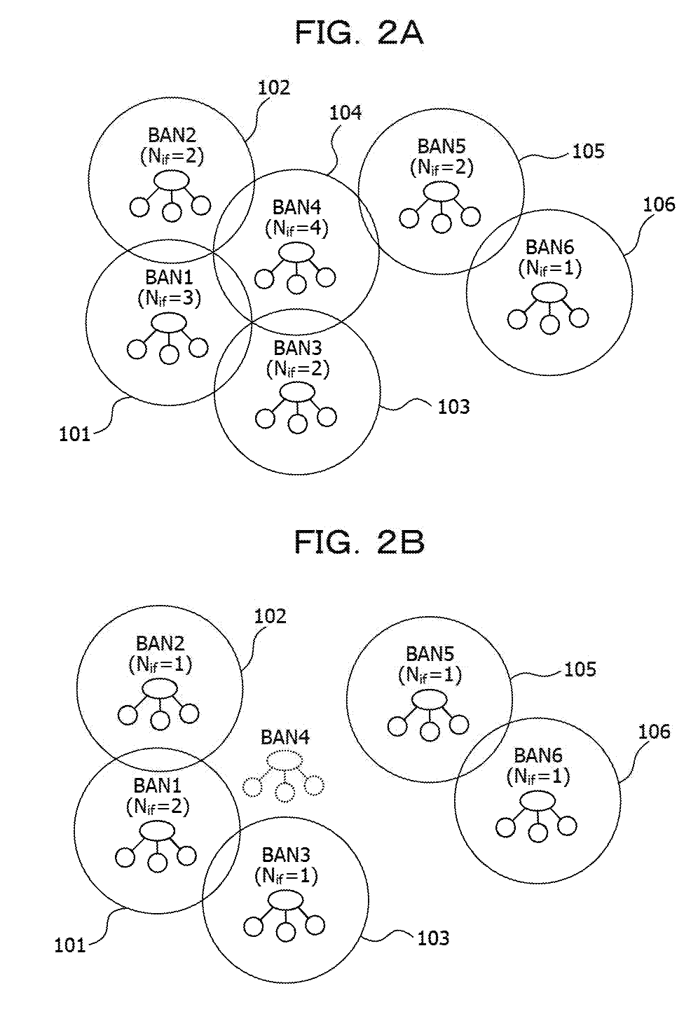

FIG. 2A is a diagram illustrating examples of wireless communication networks using the same channel before channel switching. In this example, six wireless communication networks BAN1 to BAN6 exist, and the wireless communication networks each have the same configuration as that of the wireless communication network 1 illustrated in FIG. 1. In addition, it is assumed that the wireless communication networks BAN1 to BAN6 each use the same channel.

In addition, in FIG. 2A, communicable ranges 101 to 106 of the respective wireless communication networks BAN1 to BAN6 are indicated by circles. In this example, the communicable range 101 of the wireless communication network BAN1 partially overlaps with the communicable ranges of the respective wireless communication networks BAN2 to BAN4. Accordingly, the number N_{if} of sensed networks of the wireless communication network BAN1 is “3”. In the same way, the numbers N_{if} of sensed networks of the wireless communication networks BAN2 to BAN6 are “2”, “2”, “4”, “2”, and “1”, respectively. Accordingly, among the wireless communication networks BAN1 to BAN6, the number of sensed networks (N_{if}=“4”) of the wireless communication network BAN4 is a maximum. Accordingly, the wireless communication network BAN4 switches, to another channel, a channel currently used in wireless communication between a hub and nodes.

FIG. 2B is a diagram illustrating examples of the wireless communication networks after the wireless communication network BAN4 switches a channel. In this example, among the six wireless communication networks BAN1 to BAN6, the wireless communication networks other than the wireless communication network BAN4 indicated by dotted lines use the same channel. Since the wireless communication network BAN4 having the maximum number of sensed networks switches a channel, the number of communicable ranges that overlap with each other is decreased among the communicable range 101 to 103, 105, and 106 of the respective wireless communication networks BAN1 to BAN3, BAN5, and BAN6. As a result, the numbers N_{if} of sensed networks of the respective wireless communication networks are decreased to “1”, “2”, “1”, “1”, and “1”. In addition, only the wireless communication network BAN4 switches a channel. Therefore, at this point of time, in a channel after the switching, there is no other wireless communication network that causes an interference with the wireless communication network BAN4 to occur.

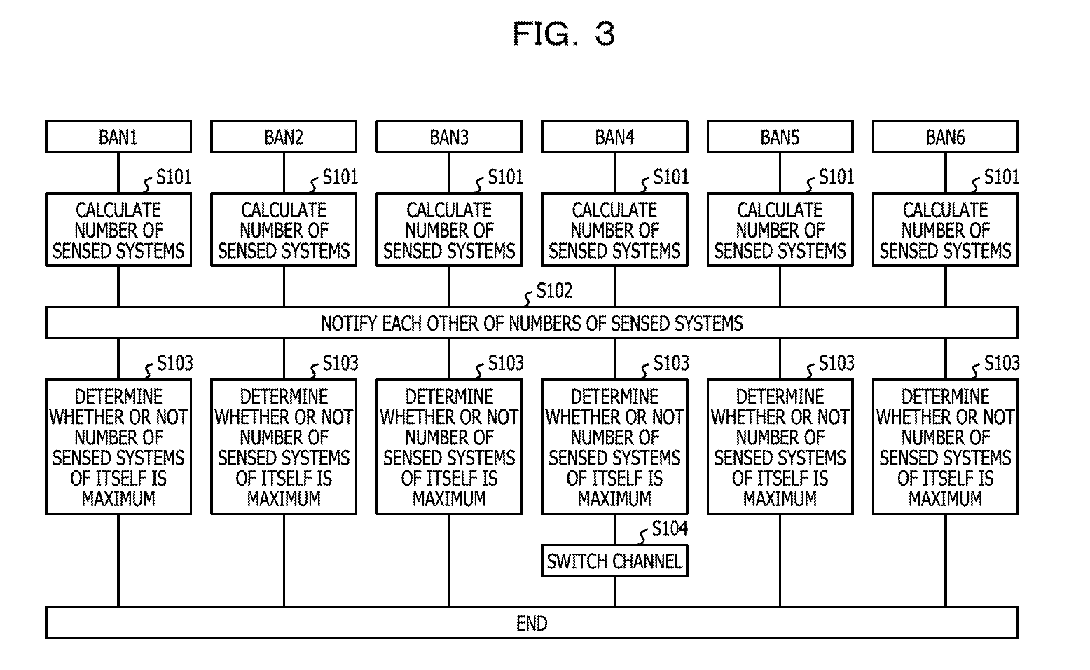

FIG. 3 is a sequence diagram illustrating a procedure of channel switching in each of the wireless communication networks illustrated in FIG. 2A and FIG. 2B.

First, each of the wireless communication networks BAN1 to BAN6 counts the number of other wireless communication networks from each of which a wireless signal is able to be received by using a currently used channel, thereby obtaining the number of sensed networks (step S101). In addition, the individual wireless communication networks BAN1 to BAN6 notifies each other of the numbers of sensed networks between wireless communication networks in which wireless signals are able to be received (step S102).

Each of the wireless communication networks BAN1 to BANG compares the number of sensed networks of the self-system and the numbers of sensed networks given notice of by other wireless communication networks with each other, thereby determining whether or not the number of sensed networks of the self-system is a maximum (step S103). In addition, a wireless communication network (in this example, BAN4) in which the number of sensed networks of the self-system is a maximum switches a currently used channel to another channel (step S104).

Note that each of the wireless communication networks may repeat the above-mentioned processing until the number of sensed networks of the self-system becomes “0” or “1”.

Hereinafter, determination of whether or not a wireless signal is able to be received from another wireless communication network will be described.

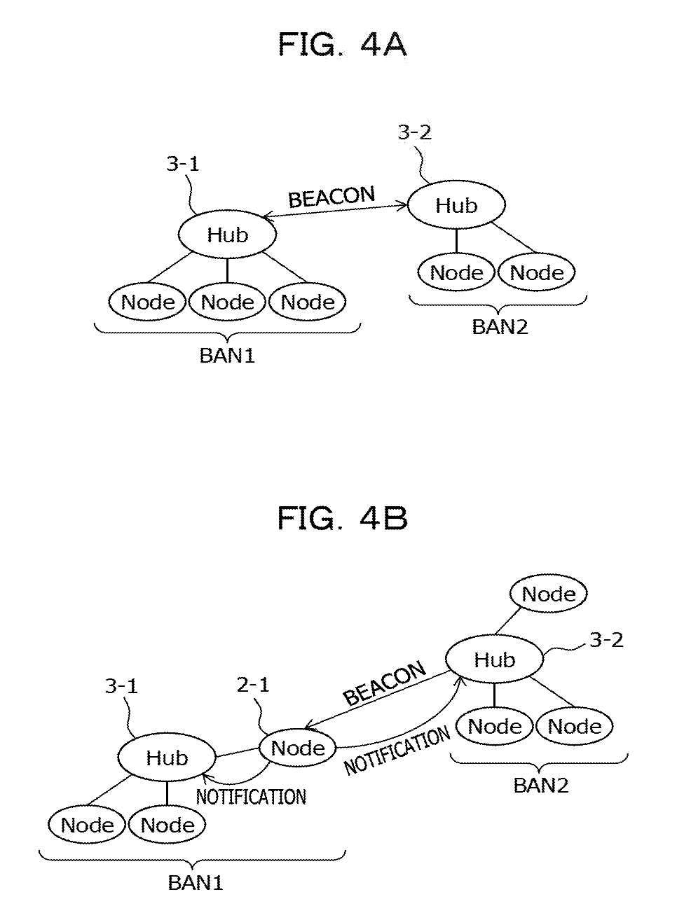

FIG. 4A is a diagram illustrating a case where a hub of one of two wireless communication networks is able to receive a wireless signal from a hub of the other of the two wireless communication networks. Note that, in FIG. 4A, it is assumed that the two wireless communication networks BAN1 and BAN2 each have the same configuration as that of the wireless communication network 1 illustrated in FIG. 1.

A hub 3-1 of the wireless communication network BAN1 determines whether or not a beacon signal emitted by a hub of another wireless communication network is able to be sensed from a wireless signal received in a channel currently used by the wireless communication network BAN1. Note that the beacon signal is a signal that is transmitted, for each of super frames each serving as a unit at a time of performing communication between a hub and a node, by the hub at the head of the relevant super frame in each of the wireless communication networks. Therefore, upon sensing the beacon signal from the received wireless signal, the hub 3-1 determines that a wireless signal is received from the hub of the other wireless communication network. Note that, by referencing header information included in the wireless signal, the hub 3-1 is able to judge whether or not that wireless signal is the beacon signal. In this example, the hub 3-1 of the wireless communication network BAN1 is located within the communicable range of a hub 3-2 of the wireless communication network BAN2. Therefore, the hub 3-1 is able to receive from a beacon signal transmitted by the hub 3-2.

In addition, the beacon signal includes a network identifier for identifying a wireless communication network. Therefore, by acquiring the network identifier from the sensed beacon signal, the hub 3-1 is able to identify a wireless communication network to which the hub that transmits that beacon signal belongs. For this reason, even in a case where three or more wireless communication networks exist and the hub 3-1 is able to receive beacon signals form hubs of respective other wireless communication networks, the hub 3-1 is able to count the number of wireless communication networks from each of which a wireless signal is able to be received.

FIG. 4B is a diagram illustrating a case where one of nodes of one of the two wireless communication networks is able to receive a wireless signal from a hub of the other of the two wireless communication networks. Note that, in FIG. 4B, it is assumed that the two wireless communication networks BAN1 and BAN2 each have the same configuration as that of the wireless communication network 1 illustrated in FIG. 1.

In this case, a node 2-1 of the wireless communication network BAN1 determines whether or not a wireless signal received in a channel currently used by the wireless communication network BAN1 includes a beacon signal. In addition, in a case where the beacon signal is detected, the node 2-1 references a network identifier included in the beacon signal, thereby determining whether that beacon signal is transmitted by the hub 3-1 of the wireless communication network BAN1 or is transmitted by a hub of another wireless communication network. In a case where the received beacon signal is transmitted by the hub of the other wireless communication network, the node 2-1 determines that the other wireless communication network is detected. Note that, in a case where beacon signals are received, the node 2-1 is able to obtain the number of sensed other wireless communication networks by referencing network identifiers included in the respective beacon signals. In this example, the node 2-1 is able to receive a wireless signal from the hub 3-2 of the wireless communication network BAN2. Therefore, the node 2-1 is able to sense the wireless communication network BAN2.

By using, for example, a time slot allocated to the node 2-1 by the hub 3-1, the node 2-1 notifies the hub 3-1 of the number of other wireless communication networks sensed for the most recent given period of time (for example, several tens of milliseconds to several hundreds of milliseconds). At that time, the node 2-1 may notify the hub 3-1 of network identifiers included in the respective received beacon signals.

The hub 3-1 defines, as the number of sensed networks, the total sum of the number of other wireless communication networks sensed by the self-device and the numbers of other wireless communication networks sensed by the individual nodes included in the wireless communication network BAN1, the numbers of other wireless communication networks being given notice of by the respective nodes. Note that a corresponding one of the individual nodes gives notice of network identifiers of other wireless communication networks sensed by the relevant node, in some cases. In this case, among network identifiers given notice of by nodes and network identifiers of other wireless communication networks sensed by the hub 3-1 itself, the hub 3-1 may define, as the number of sensed networks, the number of network identifiers that have respective values different from each other. For this reason, even in a case where the hub 3-1 and one of nodes located within the same wireless communication network as that of the hub 3-1 itself each sense the same one of the other wireless communication networks, the hub 3-1 is able to inhibit the relevant wireless communication network from being doubly counted.

The hub 3-1 notifies the other wireless communication networks of the number of sensed networks of the wireless communication network BAN1 to which the hub 3-1 itself belongs. Therefore, for, for example, each of the super frames, the hub 3-1 generates a beacon signal including the network identifier of the wireless communication network BAN1 and the number of sensed networks. In addition, the hub 3-1 transmits the beacon signal for each of the super frames.

In addition, in the example illustrated in FIG. 4B, it is difficult for the hub 3-1 to directly receive radio waves from the other wireless communication networks. Therefore, it is difficult for the hub 3-1 to directly notify the other wireless communication networks of the number of sensed networks. Therefore, in this case, a node (the node 2-1 in the example of FIG. 4B) that senses the other wireless communication networks extracts the network identifier and the number of sensed networks from the beacon signal received from the hub 3-1 and causes the network identifier and the number of sensed networks to be included in a signal to be transmitted by using an association time slot. In addition, this node transmits that signal. For this reason, a hub (the hub 3-2 in the example illustrated in FIG. 4B) of a corresponding one of the other wireless communication networks is able to receive the number of sensed networks of the wireless communication network BAN1.

Hereinafter, details of a node and a hub will be described. Note that since, regarding wireless communication functions, the nodes 2-1 to 2-N are able to have the same configuration, the node 2-1 will be described hereinafter.

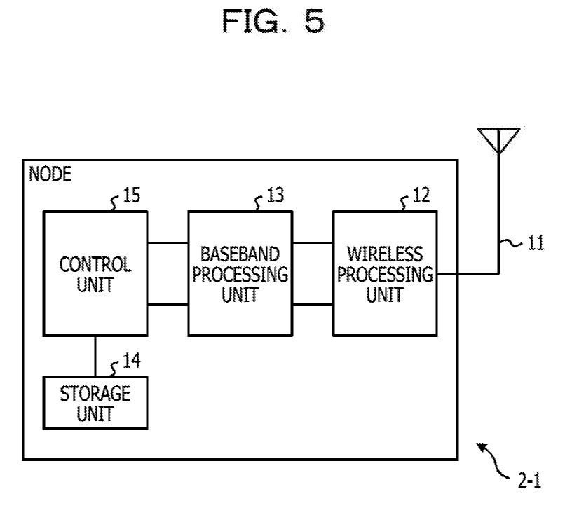

FIG. 5 is a schematic configuration diagram of the node 2-1. The node 2-1 includes an antenna 11, a wireless processing unit 12, a baseband processing unit 13, a storage unit 14, and a control unit 15.

The antenna 11 transmits, to the hub 3 or other wireless communication networks, a wireless signal received from the wireless processing unit 12. Alternatively, the antenna 11 delivers, to the wireless processing unit 12, a wireless signal received from the hub 3 or a hub of another wireless communication network.

The wireless processing unit 12 superimposes a baseband signal received from the baseband processing unit 13, on a wireless signal having a frequency corresponding to a designated channel. In addition, the wireless processing unit 12 outputs that wireless signal to the antenna 11 while amplifying the wireless signal by using an amplifier (not illustrated).

In addition, by using an amplifier (not illustrated), the wireless processing unit 12 amplifies a wireless signal received via the antenna 11. In addition, the wireless processing unit 12 extracts a baseband signal superimposed on that wireless signal and outputs the baseband signal to the baseband processing unit 13.

The baseband processing unit 13 includes, for example, one or more processors and a peripheral circuit. In addition, the baseband processing unit 13 assigns an error correction code to a transmission signal received from the control unit 15 and modulates that transmission signal in accordance with a modulation method designated by the control unit 15, thereby generating a baseband signal. Note that the modulation method only has to be a modulation method adopted by a communication standard with which the node 2-1 is compliant. In addition, the baseband processing unit 13 outputs the baseband signal to the wireless processing unit 12.

In addition, the baseband processing unit 13 demodulates the baseband signal received from the wireless processing unit 12, in accordance with a modulation method applied to that baseband signal, and performs thereon error correction decoding, thereby reproducing a reception signal. In addition, the baseband processing unit 13 outputs that reception signal to the control unit 15.

The storage unit 14 includes, for example, a non-volatile read-only semiconductor memory circuit and a volatile readable and writable semiconductor memory circuit. In addition, the storage unit 14 stores therein pieces of information such as, for example, a computer program to be executed by the control unit 15, the network identifier of the wireless communication network 1 to which the node 2-1 belongs, and data to be transmitted to the hub 3.

The control unit 15 includes, for example, one or more processors and a peripheral circuit. Note that the control unit 15 and the baseband processing unit 13 may be formed as one integrated circuit. In addition, the control unit 15 performs communication control such as establishment of coupling to the hub 3, in accordance with a communication method with which the wireless communication network 1 is compliant.

In addition, the control unit 15 extracts information included in the reception signal and stores that information in the storage unit 14 or performs processing corresponding to that information. The control unit 15 determines whether or not the reception signal is a beacon signal, for example, and in a case where the reception signal is the beacon signal, the control unit 15 extracts a network identifier included in that beacon signal. In addition, the control unit 15 compares the extracted network identifier with the network identifier of the wireless communication network 1. In a case where the extracted network identifier is different from the network identifier of the wireless communication network 1, the control unit 15 determines that another wireless communication system is detected. In addition, the control unit 15 stores, in the storage unit 14, the network identifier extracted from that beacon signal and the number of sensed networks.

In addition, in a case where the extracted network identifier is coincident with the network identifier of the wireless communication network 1, the control unit 15 determines that the received beacon signal is transmitted by the hub 3. In addition, in this case, the control unit 15 stores, in the storage unit 14, the network identifier included in that beacon signal and the number of sensed networks.

Furthermore, the control unit 15 extracts control information (for example, information indicating allocations of time slots, information indicating a used channel, and so forth) included in the reception signal from the hub 3 and stores the control information in the storage unit 14.

In addition, the control unit 15 generates a transmission signal to the hub 3. That transmission signal includes a transmission signal, used for control and used for establishment of communication and so forth, and a transmission signal used for data communication. The transmission signal used for data communication includes a sensor signal received from a sensor (for example, a pulsimeter, a clinical thermometer, or the like, not illustrated) included in the node 2-1, for example.

Furthermore, the control unit 15 may cause a network identifier received from another wireless communication network and the number of sensed networks to be included in the transmission signal used for control or the transmission signal used for data communication. In addition, furthermore, the control unit 15 may cause the number of other wireless communication networks sensed for the most recent given period of time to be included in the transmission signal used for control or the transmission signal used for data communication.

The control unit 15 outputs the generated transmission signal to the baseband processing unit 13. In addition, the control unit 15 controls the baseband processing unit 13 and the wireless processing unit 12 so that a wireless signal including that transmission signal is transmitted by using time slots allocated to the node 2-1 and by using a designated channel.

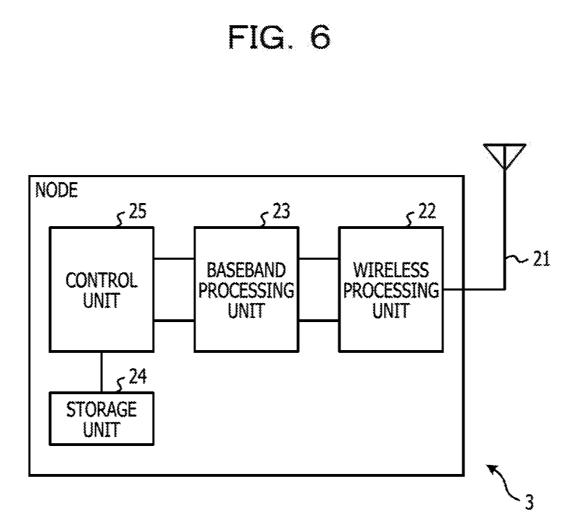

FIG. 6 is a schematic configuration diagram of the hub 3. The hub 3 includes an antenna 21, a wireless processing unit 22, a baseband processing unit 23, a storage unit 24, and a control unit 25.

The antenna 21 transmits a wireless signal received from the wireless processing unit 22 to one or all of the nodes 2-1 to 2-N, another wireless communication network, or an access point. Alternatively, the antenna 21 delivers, to the wireless processing unit 22, a wireless signal received from one of the nodes 2-1 to 2-N, a hub of another wireless communication network, or an access point.

The wireless processing unit 22 superimposes a baseband signal received from the baseband processing unit 23 on a carrier wave having a frequency corresponding to a designated channel, thereby generating a wireless signal. In addition, the wireless processing unit 22 amplifies that wireless signal by using an amplifier (not illustrated), thereby outputting the wireless signal to the antenna 21.

In addition, by using an amplifier (not illustrated), the wireless processing unit 22 amplifies a wireless signal received via the antenna 21. In addition, the wireless processing unit 22 extracts a baseband signal superimposed on that wireless signal and outputs the baseband signal to the baseband processing unit 23.

The baseband processing unit 23 includes, for example, one or more processors and a peripheral circuit. In addition, the baseband processing unit 23 assigns an error correction code to a transmission signal received from the control unit 25 and modulates that transmission signal in accordance with a modulation method designated by the control unit 25, thereby generating a baseband signal. Note that the modulation method only has to be a modulation method adopted by a communication standard with which the hub 3 is compliant. In addition, the baseband processing unit 23 outputs the baseband signal to the wireless processing unit 22.

In addition, the baseband processing unit 23 demodulates the baseband signal received from the wireless processing unit 22, in accordance with a modulation method applied to that baseband signal, and performs thereon error correction decoding, thereby reproducing a reception signal. In addition, the baseband processing unit 23 outputs that reception signal to the control unit 25.

The storage unit 24 includes, for example, a non-volatile read-only semiconductor memory circuit and a volatile readable and writable semiconductor memory circuit. In addition, the storage unit 24 stores therein pieces of information such as, for example, a computer program to be executed by the control unit 25, the network identifier of the wireless communication network 1 to which the hub 3 belongs, and control information to be used for communication with the individual nodes.

The control unit 25 includes, for example, one or more processors and a peripheral circuit. Note that the control unit 25 and the baseband processing unit 23 may be formed as one integrated circuit. In addition, in accordance with a communication method with which the wireless communication network 1 is compliant, the control unit 15 performs communication control such as establishment of coupling to the individual nodes, selection of a channel, and allocations of time slots. Furthermore, the control unit 25 may perform communication control used for communication with an access point, such as establishment of coupling to the access point.

In addition, the control unit 25 extracts information or data included in the reception signal and stores that information or data in the storage unit 24 or performs processing corresponding to that information or data. The control unit 25 determines whether or not the reception signal is a beacon signal, for example, and in a case where the reception signal is the beacon signal, the control unit 25 extracts a network identifier and the number of sensed networks, included in that beacon signal. In addition, the control unit 25 stores, in the storage unit 24, the network identifier and the number of sensed networks, which are extracted.

In addition, in a case where a network identifier and the number of sensed other wireless communication networks are included in a reception signal from one of the individual nodes, the control unit 25 stores, in the storage unit 24, that network identifier and the number of sensed other wireless communication networks. In addition, the control unit 25 calculate the number of sensed networks for each of predetermined periods (for example, periods each equal to the length of a super frame). At that time, as described above, the control unit 25 adds the number of other wireless communication networks sensed from signals received within the most recent given period of time by the hub 3 itself and a total number of sensed other wireless communication networks given notice of by the respective nodes, thereby calculating the number of sensed networks. Alternatively, among network identifiers of other wireless communication networks sensed within the most recent given period of time by the hub 3 itself and network identifiers of sensed other wireless communication networks given notice of by the respective nodes, the control unit 25 may count the number of network identifiers different from one another. In addition, the control unit 25 may define that number as the number of sensed networks.

For each of predetermined periods, the control unit 25 compares the numbers of sensed networks of the respective other wireless communication networks and the number of sensed networks of the wireless communication network 1. In addition, in a case where the number of sensed networks of the wireless communication network 1 is a maximum, the control unit 25 sets a timing of switching a channel and causes information for designating a channel after switching to be included in a beacon signal or the like, thereby notifying the individual nodes thereof. In a case where that timing arrives, the control unit 25 switches a channel used for communication with the nodes 2-1 to 2-N from a currently used channel to another channel.

Furthermore, in a case where, in the most recent predetermined time period, a packet error rate or a reception strength (received signal strength indicator (RSSI)) at a time of reproducing a signal received from one of the individual nodes becomes greater than or equal to a predetermined threshold value, the control unit 25 may determine that an interference occurs. Alternatively, in a case where an average value of signal-to-noise ratios for the most recent predetermined time period becomes less than or equal to a predetermined threshold value, the control unit 25 may determine that an interference occurs. In addition, in a case where it is determined that an interference occurs, the control unit 25 may switch a channel used for communication with the nodes 2-1 to 2-N from a currently used channel to another channel.

Note that the control unit 25 may randomly set a channel after switching or may set a channel after switching, in accordance with a predetermined rule.

Furthermore, for each of super frames, the control unit 25 generates a beacon signal including a network identifier and the number of sensed networks and outputs that beacon signal to the baseband processing unit 23. In addition, the control unit 25 controls the baseband processing unit 23 and the wireless processing unit 22 so that a wireless signal including that beacon signal is transmitted by using a predetermined interval at the head of the super frame and by using a designated channel.

Note that the hub 3 may include an antenna and a wireless processing unit, which are used for communication with an access point and which are different from the antenna 21 and the wireless processing unit 22, used for communication with the individual nodes.

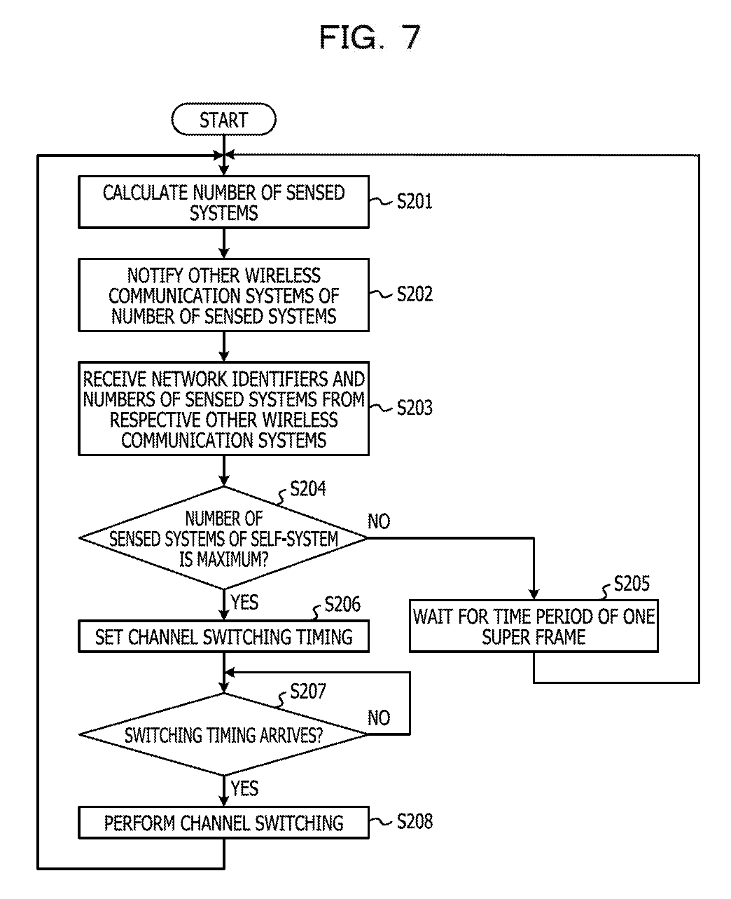

FIG. 7 is an operation flowchart of channel switching processing performed by the control unit 25 in the hub 3.

Based on whether or not wireless signals are able to be received from other wireless communication networks different from the wireless communication network 1 to which the hub 3 belongs, the control unit 25 obtains the number of sensed networks serving as the number of other communication systems each of which uses the same channel and from each of which a wireless signal is able to be received (step S201). In addition, the control unit 25 causes the number of sensed networks and a network identifier to be included in a beacon signal, thereby notifying other wireless communication networks of the number of sensed networks (step S202). In addition, the control unit 25 receives, from other wireless communication networks, network identifiers and the numbers of sensed networks of the respective other wireless communication networks (step S203).

The control unit 25 determines whether or not the number of sensed networks regarding the wireless communication network to which the hub 3 belongs is a maximum (step S204). In a case where the number of sensed networks regarding the wireless communication network to which the hub 3 belongs is not a maximum (step S204—No), the control unit 25 waits for a time period corresponding to one super frame, regarding switching of a channel (step S205). In addition, the control unit 25 repeats processing operations in and after step S201.

On the other hand, in a case where the number of sensed networks regarding the wireless communication network to which the hub 3 belongs is a maximum (step S204—Yes), the control unit 25 sets a channel switching timing (step S206). The control unit 25 defines, as a channel switching timing, a time of the start of a super frame after a predetermined number of super frames (for example, one or two super frames), for example. In addition, the control unit 25 generates a signal (for example, a beacon signal) including information indicating a channel after switching and information indicating a switching timing and transmits that signal to the individual nodes. In addition, the control unit 25 determines whether or not a current time reaches the channel switching timing (step S207). In a case where the current time does not reach the channel switching timing (step S207—No), the control unit 25 performs the processing operation in step S207 again after a given period of time elapses.

On the other hand, in a case where the current time reaches the channel switching timing (step S207—Yes), the control unit 25 switches a currently used channel to another channel (step S208). After that, the control unit 25 repeats processing operations in and after step S201. Note that the control unit 25 may perform the processing operation in step S203 before step S201 or between step S201 and step S202.

As described above, in a case where each of wireless communication networks detects other wireless communication networks that use the same channel, a wireless communication network having the maximum number of sensed networks switches a channel, and each of the other wireless communication networks does not a channel. Therefore, according to the present embodiment, it is possible to decrease the number of wireless communication networks that each simultaneously a channel. Therefore, a possibility that the same channel is used again in wireless communication networks after channel switching is reduced. As a result thereof, it is possible for this wireless communication network to suppress the occurrence of an interference in a channel after the switching.

Note that wireless communication networks each having the maximum number of sensed networks exist in some cases. In such a case, in a case where those wireless communication networks simultaneously switch channels, there is a possibility that channels after the switching become equal regarding wireless communication networks. Therefore, according to an example of a modification, in a case where the number of sensed networks of a wireless communication network to which a hub itself belongs is a maximum and another wireless communication network having the same number of sensed networks exists, the hub may determine, based on an evaluation value indicating a communication traffic or a communication state, whether or not to switch a channel.

Note that, in this example of a modification, the hub 3 and the individual nodes 2-1 to 2-N have the same configurations as those of the hub and the individual nodes according to the above-mentioned embodiment except for processing related to the evaluation value. Therefore, in what follows, a point different from the above-mentioned embodiment and a related portion thereof will be described.

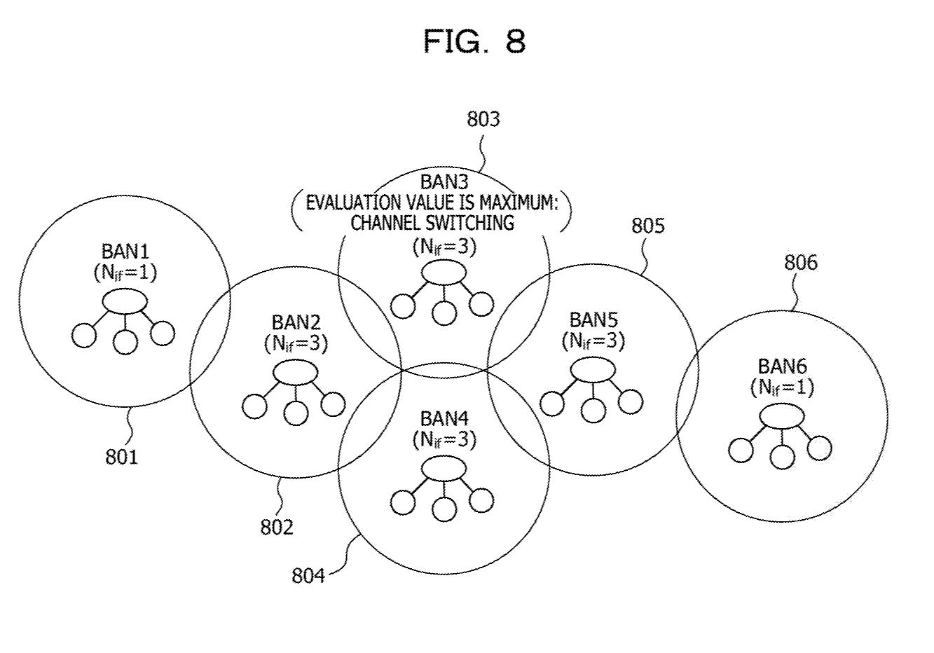

FIG. 8 is a diagram illustrating an example of a case where wireless communication networks each having the maximum number of sensed networks exist. Note that, in this example, six wireless communication networks BAN1 to BAN6 exist and the wireless communication networks each have the same configuration as that of the wireless communication network 1 illustrated in FIG. 1. In addition, it is assumed that the wireless communication networks BAN1 to BAN6 each use the same channel.

In addition, in FIG. 8, communicable ranges 801 to 806 of the respective wireless communication networks BAN1 to BAN6 are indicated by circles. In addition, it is assumed that wireless communication networks for which communicable ranges thereof partially overlap with each other are able to receive wireless signals from each other. In this example, the number of sensed networks N_{if} of each of the wireless communication networks BAN2 to BAN5 is “3” and is a maximum. In this case, in the above-mentioned embodiment, the wireless communication networks BAN2 to BAN5 each turn out to switch a channel.

However, in this example of a modification, among the wireless communication networks BAN2 to BAN5, only a wireless communication network having a maximum evaluation value switches a channel. In a case where the evaluation value of, for example, the wireless communication network BAN3 is a maximum, the wireless communication system BAN3 switches a channel, and none of the other wireless communication networks BAN2, BAN4, and BAN5 switch channels. Therefore, according to this example of a modification, a possibility that channels after switching become equal in two or more wireless communication networks is further reduced.

Note that, as the evaluation value, a packet error rate or a communication traffic per unit time in the most recent predetermined time period (for example, a time period corresponding to one or more super frames) is used, for example. A hub of each of the wireless communication networks calculates the total sum of data amounts transmitted and data amounts received in respective super frames within the most recent predetermined time period and divides the total sum by the predetermined time period, thereby being able to calculate a communication traffic per unit time, for example.

In addition, in this example of a modification, a hub of each of the wireless communication networks causes an evaluation value to be included in a beacon signal of each of the super frames, along with a network identifier and the number of sensed networks. In addition, a node that notifies other wireless communication networks of the number of sensed networks may cause an evaluation value to be included in a signal transmitted by using an association time slot, along with a network identifier and the number of sensed networks. For this reason, wireless communication networks that receive wireless signals from one another are able to share the numbers of sensed networks and evaluation values of one another.

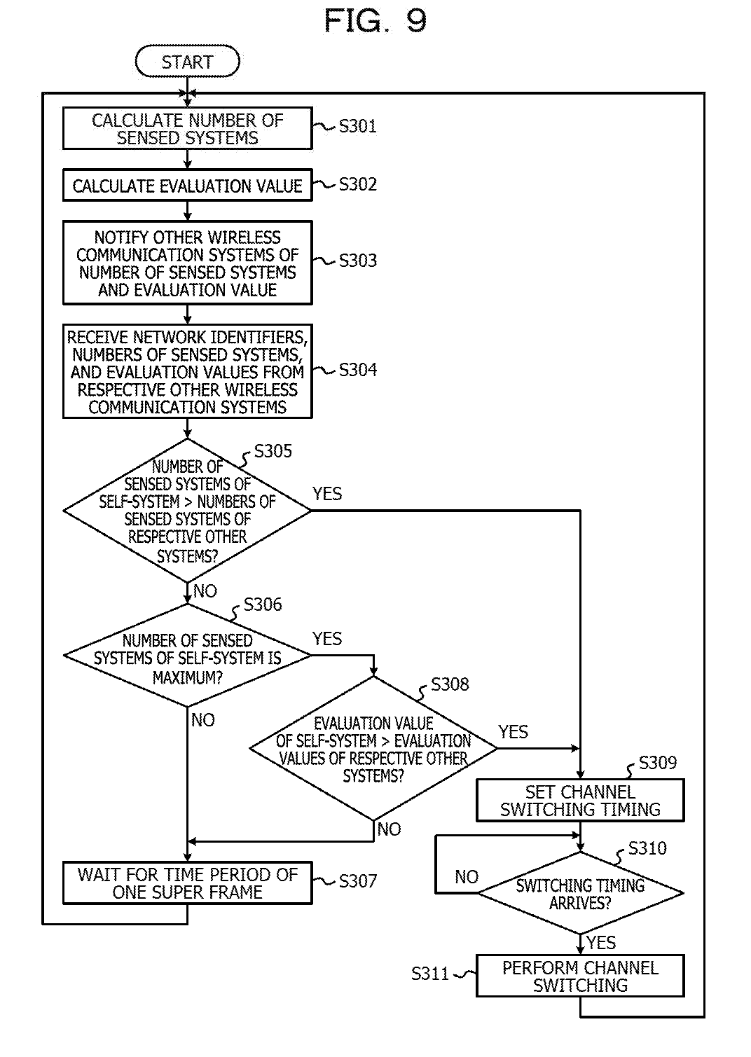

FIG. 9 is an operation flowchart of channel switching processing based on this example of a modification and performed by the control unit 25 in the hub 3.

Based on whether or not wireless signals are able to be received from other wireless communication networks different from the wireless communication network 1 to which the hub 3 belongs, the control unit 25 obtains the number of sensed networks serving as the number of other communication systems each of which uses the same channel and from each of which a wireless signal is able to be received (step S301). In addition, the control unit 25 calculates an evaluation value indicating a communication traffic or a communication state (step S302). In addition, the control unit 25 causes the number of sensed networks, the network identifier, and the evaluation value to be included in a beacon signal, thereby notifying other wireless communication networks of the number of sensed networks and the evaluation value (step S303). In addition, the control unit 25 receives, from other wireless communication networks, network identifiers, the numbers of sensed networks, and evaluation values of the respective other wireless communication networks (step S304).

The control unit 25 determines whether or not the number of sensed networks of the wireless communication network to which the hub 3 belongs is greater than the numbers of sensed networks of the respective other wireless communication networks (step S305). In a case where the number of sensed networks of the wireless communication network to which the hub 3 belongs is less than or equal to the number of sensed networks of one of the other wireless communication networks (step S305—No), the control unit 25 determines whether or not the number of sensed networks of the wireless communication network to which the hub 3 belongs is a maximum (step S306). In a case where the number of sensed networks of the wireless communication network to which the hub 3 belongs is not a maximum (step S306—No), the control unit 25 waits for a time period corresponding to one super frame, regarding switching of a channel (step S307). In addition, the control unit 25 repeats processing operations in and after step S301.

On the other hand, in a case where the number of sensed networks of the wireless communication network to which the hub 3 belongs is a maximum (step S306—Yes), one of the other wireless communication networks, which has the same number of sensed networks as the number of sensed networks regarding the wireless communication network to which the hub 3 belongs, exists. Therefore, the control unit 25 determines whether or not the evaluation value is greater than the evaluation values of the respective other wireless communication networks each having the same number of sensed networks (step S308).

In a case where the evaluation value is less than or equal to the evaluation value of one of the other wireless communication networks each having the same number of sensed networks (step S308—No), the control unit 25 waits for a time period corresponding to one super frame, regarding switching of a channel (step S307). In addition, the control unit 25 repeats processing operations in and after step S301.

In a case where the evaluation value is greater than the evaluation values of the respective other wireless communication networks each having the same number of sensed networks (step S308—Yes), the control unit 25 sets a channel switching timing (step S309). The control unit 25 defines, as the channel switching timing, a time of the start of a super frame after a predetermined number of super frames (for example, one or two super frames), for example. In addition, the control unit 25 generates a signal including information indicating a channel after switching and transmits that signal to the individual nodes. After that, the control unit 25 determines whether or not a current time reaches the channel switching timing (step S310). In a case where the current time does not reach the channel switching timing (step S310—No), the control unit 25 performs the processing operation in step S310 again after a given period of time elapses.

On the other hand, in a case where the current time reaches the channel switching timing (step S310—Yes), the control unit 25 switches a currently used channel to another channel (step S311). After that, the control unit 25 repeats processing operations in and after step S301.

In addition, in a case where the number of sensed networks regarding the wireless communication network to which the hub 3 belongs is greater than the numbers of sensed networks of the respective other wireless communication networks (step S305—Yes), the control unit 25 performs processing operations in and after step S309.

Note that the control unit 25 may perform the processing operation in step S304 before step S301, between step S301 and step S302, or between step S302 and step S303. In addition, in a case where, in step S308, the evaluation value of the wireless communication network to which the hub 3 belongs is greater than or equal to the evaluation values of the respective other wireless communication networks each having the same number of sensed networks, the control unit 25 may determine that the processing operations in and after step S309 are to be performed.

As described above, according to this example of a modification, even in a case where wireless communication networks each having the maximum number of sensed networks exist, one of the wireless communication networks switches a channel, and none of the other wireless communication networks switch channels. Therefore, according to this example of a modification, it is possible to further decrease the number of wireless communication networks that each simultaneously a channel. Therefore, a possibility that the same channel is used again in wireless communication networks after channel switching is further reduced. Therefore, it is possible for this wireless communication network to further suppress a possibility that an interference occurs in a channel after switching.

In addition, according to another example of a modification, each of the wireless communication networks may notify other wireless communication networks of a channel scheduled to be switched, along the number of sensed networks. In this case, a hub of each of the wireless communication networks only has to further cause a channel scheduled to be switched to be included in a beacon signal, for example. In addition, a hub of the wireless communication network that switches a channel only has to select, as a channel to serve as a switching destination, a channel different from a channel scheduled to be switched in a wireless communication network for which a channel is switched in advance and which is included in the other wireless communication networks. Note that, regarding other wireless communication networks for each of which the number of sensed networks is given notice of within a predetermined time period before switching of a channel and for each of which, at a time of determination of switching of a channel, the number of sensed networks is not given notice of, the hub may determine that channels are switched in advance.

According to this example of a modification, a wireless communication network to subsequently switch a channel is inhibited from switching to the same channel as a channel used by a wireless communication network that switched a channel in advance.

According to yet another example of a modification, in a case where wireless communication networks are able to access the same access point, a hub of each of the wireless communication networks may notify other wireless communication networks of the number of sensed networks and an evaluation value via the access point.

All the examples and specific terms, cited herein, are intended for pedagogical purposes to aid readers in understanding the present disclosure and the concepts contributed by the present inventor for the promotion of the relevant technology and are desired to be interpreted as not being limited to a configuration of any example of the present specification, related to an indication of superiority or inferiority of the present disclosure, or such a cited specific example or condition. Although the embodiments of the present disclosure are described in detail, it will be understood that various alterations, substitutions, and modifications could be made hereto without departing from the spirit and scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of controlling wireless communication channels used in a plurality of wireless communication networks including a first wireless communication network and a second wireless communication network, each of the plurality of wireless communication networks including a plurality of wireless communication devices, the method comprising:
performing, by a first wireless communication device included in the first wireless communication network, wireless communication using a first wireless channel;
performing, by a second wireless communication device included in the second wireless communication network, wireless communication using of the first wireless channel;
identifying, by the first wireless communication device, a first value indicating a number of the wireless communication networks which are included in the plurality of wireless communication networks and which are other than the first wireless communication network, and each of which performs wireless communication using the first wireless channel interfering with the wireless communication in the first wireless communication device;
identifying, by the second wireless communication device, a second value indicating a number of the wireless communication networks which are included in the plurality of wireless communication networks and which are other than the second wireless communication network, and each of which performs wireless communication using the first wireless channel interfering with the wireless communication in the second wireless communication device;
obtaining, by the first wireless communication from the second wireless communication device, the second value; and
switching, when the first value is greater than the second value, by the first wireless communication device, the first wireless channel used in the wireless communication in the first wireless communication network to a second wireless channel.

2. The method according to claim 1, further comprising:
identifying, by the first wireless communication device, a first communication traffic in the wireless communication in the first wireless communication network;
identifying, by the second wireless communication device, a second communication traffic in the wireless communication in the second wireless communication network; and
determining, by the first wireless communication device, when the first value and the second value are the same value, based on the first communication traffic and the second communication traffic, whether to switch the first wireless channel used in the wireless communication in the first wireless network to the second wireless channel.

3. The method according to claim 2, wherein
in the switching, when the first communication traffic is greater than the second communication traffic, the first wireless communication device switches the first wireless channel used in the wireless communication in the first wireless network to the second wireless channel.

4. The method according to claim 1, further comprising:
identifying, by the first wireless communication device, a first communication state in the wireless communication in the first wireless communication network;
identifying, by the second wireless communication device, a second communication state in the wireless communication in the second wireless communication network; and
determining, when the first value and the second value are the same value, by the first wireless communication device, based on the first communication state and the second communication state, whether to switch the first wireless channel used in the wireless communication in the first wireless network to the second wireless channel.

5. The method according to claim 4, wherein
in the switching, when the first communication state is better than the second communication state, the first wireless communication device switched the first wireless channel used in the wireless communication in the first wireless network to the second wireless channel.

6. The method according to claim 1, further comprising:
transmitting, by a third wireless communication device included in the first wireless communication network, the second value to the first wireless communication device when the third wireless communication device receives a wireless signal using the first wireless channel from the second wireless communication network.

7. The method according to claim 6, further comprising:
transmitting, by the third wireless communication device, the first value transmitted by the first wireless communication device to the second wireless communication network.

8. A first wireless communication network included in a plurality of wireless communication network, each of the plurality of wireless communication networks including a plurality of wireless communication devices, the first wireless communication network comprising:
a first wireless communication device included in the plurality of wireless communication devices of the first wireless communication network, wherein
the first wireless communication device includes a memory and a processor coupled to the memory, the processor is configured to:
perform wireless communication using a first wireless channel,
identify a first value indicating a number of the wireless communication networks which are included in the plurality of wireless communication networks and which are other than the first wireless communication network, and each of which performs wireless communication using the first wireless channel interfering with the wireless communication in the first wireless communication device,
obtain, from a second wireless communication device included in the plurality of wireless communication devices of a second wireless communication network included in the plurality of wireless communication network, a second value indicating a number of the wireless communication networks which are included in the plurality of wireless communication networks and which are other than the second wireless communication network, and each of which performs wireless communication using the first wireless channel interfering with the wireless communication in the second wireless communication device, and
switch, when the first value is greater than the second value, the first wireless channel used in the wireless communication in the first wireless communication network to a second wireless channel.

9. The first wireless communication network according to claim 8, the processor is further configured to:
identify a first communication traffic in the wireless communication in the first wireless communication network,
obtain, from the second wireless communication device, a second communication traffic in the wireless communication in the second wireless communication network, and
determine, when the first value and the second value are the same value, based on the first communication traffic and the second communication traffic, whether to switch the first wireless channel used in the wireless communication in the first wireless network to the second wireless channel.

10. The first wireless communication network according to claim 9, wherein the processor is configured to switch, when the first communication traffic is greater than the second communication traffic, the first wireless channel used in the wireless communication in the first wireless network to the second wireless channel.

11. The first wireless communication network according to claim 8, wherein the processor is further configured to:
identify a first communication state in the wireless communication in the first wireless communication network,
obtain, from the second wireless communication device, a second communication state in the wireless communication in the second wireless communication network, and
determine, when the first value and the second value are the same value, based on the first communication state and the second communication state, whether to switch the first wireless channel used in the wireless communication in the first wireless network to the second wireless channel.

12. The first wireless communication network according to claim 11, wherein the processor is configured to switch, when the first communication state is better than the second communication state, the first wireless channel used in the wireless communication in the first wireless network to the second wireless channel.

13. The first wireless communication network according to claim 8, wherein
a third wireless communication device included in the first wireless communication network transmits the second value to the first wireless communication device when the third wireless communication device receives a wireless signal using the first wireless channel from the second wireless communication network.

14. The first wireless communication network according to claim 13, wherein the third wireless communication device transmits the first value transmitted by the first wireless communication device to the second wireless communication network.

15. A first wireless communication device included in a first wireless communication network included in a plurality of wireless communication network, each of the plurality of wireless communication networks including a plurality of wireless communication devices, the first wireless communication device comprising:
a memory; and
a processor coupled to the memory is configured to:
perform wireless communication using a first wireless channel,
identify a first value indicating a number of the wireless communication networks which are included in the plurality of wireless communication networks and which are other than the first wireless communication network, and each of which performs wireless communication using the first wireless channel interfering with the wireless communication in the first wireless communication device,
obtain, from a second wireless communication device included in the plurality of wireless communication devices of a second wireless communication network included in the plurality of wireless communication network, a second value indicating a number of the wireless communication networks which are included in the plurality of wireless communication networks and which are other than the second wireless communication network, and each of which performs wireless communication using the first wireless channel interfering with the wireless communication in the second wireless communication device, and
switch, when the first value is greater than the second value, the first wireless channel used in the wireless communication in the first wireless communication network to a second wireless channel.

16. The first wireless communication device according to claim 15, the processor is further configured to:
identify a first communication traffic in the wireless communication in the first wireless communication network,
obtain, from the second wireless communication device, a second communication traffic in the wireless communication in the second wireless communication network, and
determine, when the first value and the second value are the same value, based on the first communication traffic and the second communication traffic, whether to switch the first wireless channel used in the wireless communication in the first wireless network to the second wireless channel.

17. The first wireless communication device according to claim 16, wherein the processor is configured to switch, when the first communication traffic is greater than the second communication traffic, the first wireless channel used in the wireless communication in the first wireless network to the second wireless channel.

18. The first wireless communication device according to claim 15, wherein the processor is further configured to:
identify a first communication state in the wireless communication in the first wireless communication network,
obtain, from the second wireless communication device, a second communication state in the wireless communication in the second wireless communication network, and
determine, when the first value and the second value are the same value, based on the first communication state and the second communication state, whether to switch the first wireless channel used in the wireless communication in the first wireless network to the second wireless channel.

19. The first wireless communication device according to claim 18, wherein the processor is configured to switch, when the first communication state is better than the second communication state, the first wireless channel used in the wireless communication in the first wireless network to the second wireless channel.

20. The first wireless communication device according to claim 15, wherein
a third wireless communication device included in the first wireless communication network transmits the second value to the first wireless communication device when the third wireless communication device receives a wireless signal using the first wireless channel from the second wireless communication network.
